(19) United States
(12) Patent Application Publication
(10) Pub. No.: US 2024/0356607 A1
(43) Pub. Date: Oct. 24, 2024

(54) CHANNEL STATE INFORMATION OMISSION FOR TYPE II CHANNEL STATE INFORMATION

(71) Applicant: Telefonaktiebolaget LM Ericsson (publ), Stockholm (SE)

(72) Inventors: Xinlin ZHANG, Västra Frölunda (SE); Fredrik ATHLEY, Västra Frölunda (SE); Mattias FRENNE, Uppsala (SE); Shiwei GAO, Nepean (CA); Siva MURUGANATHAN, Stittsville (CA)

(21) Appl. No.: 18/683,983

(22) PCT Filed: Aug. 19, 2022
(86) PCT No.: PCT/IB2022/057816

§ 371 Date: Feb. 15, 2024

Related U.S. Application Data
(60) Provisional application No. 63/234,981, filed on Aug. 19, 2021.

(51) Int. Cl. H04B 7/06; H04B 7/0456

(52) U.S. Cl. CPC H04B 7/0626; H04B 7/0456

(57) ABSTRACT

A method, network node and wireless device for channel state information (CSI) omission for Type II CSI are disclosed. According to one aspect, a method in a network node includes receiving from a wireless device (WD) an indication of a CSI reporting capability. The method includes configuring the WD to report frequency domain (FD) basis vector information in one of a CSI reporting Group 1 and a CSI reporting Group 0, based at least in part on the indicated CSI reporting capability.

### TECHNICAL FIELD

The present disclosure relates to wireless communications, and in particular, to channel state information (CSI) omission for type II CSI.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Wireless communication systems according to the 3GPP may include one or more of the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

### Codebook-Based Precoding

Multi-antenna techniques can significantly increase the data rates and reliability of a wireless communication system. The performance is improved if both the transmitter and the receiver are equipped with multiple antennas, which results in a multiple-input multiple-output (MIMO) communication channel. Such systems and/or related techniques are commonly referred to as MIMO.

The NR standard is currently evolving with enhanced MIMO support. A core component in NR is the support of MIMO antenna deployments and MIMO related techniques like, for instance, spatial multiplexing. The spatial multiplexing mode is aimed for high data rates in favourable channel conditions. An illustration of the spatial multiplexing operation is provided in the example of FIG. 1.

As seen, the information carrying symbol vector s is multiplied by an N_{T}×r precoder matrix W, which serves to distribute the transmit energy in a subspace of the N_{T} (corresponding to N_{T} antenna ports) dimensional vector space. The precoder matrix is typically selected from a codebook of possible precoder matrices, and typically indicated by means of a precoder matrix indicator (PMI), which specifies a unique precoder matrix in the codebook for a given number of symbol streams. The r symbols in s each correspond to a layer and r is referred to as the transmission rank. In this way, spatial multiplexing is achieved since multiple symbols can be transmitted simultaneously over the same time/frequency resource element (TFRE). The number of symbols r is typically adapted to suit the current channel properties. NR uses orthogonal frequency division multiplexing (OFDM) in the downlink (and discrete Fourier transform (DFT)-precoded OFDM in the uplink for rank-1 transmission). Hence the received N_{R}×1 vector yₙ for a certain TFRE on subcarrier n (or alternatively data TFRE number n) is thus modelled by:

$${y}_{n} = {H}_{n} W {s}_{n} + {e}_{n}$$

where eₙ is a noise/interference vector obtained as realizations of a random process. The precoder W can be a wideband precoder, which is constant over frequency, or frequency selective. The precoder matrix W is often chosen to match the characteristics of the N_{R}×N_{T} MIMO channel matrix Hₙ, resulting in so-called channel dependent precoding. This is also commonly referred to as closed-loop precoding and essentially strives for focusing the transmit energy into a subspace which is strong in the sense of conveying much of the transmitted energy to the WD.

In closed-loop precoding for the NR downlink, the WD transmits, based on channel measurements in the downlink, recommendations to the gNB (network node) of a suitable precoder to use. The network node configures the WD to provide feedback according to CSI-ReportConfig and may transmit channel state information reference signals (CSI-RS). The network node also configures the WD to use measurements of CSI-RS to feedback recommended precoding matrices that the WD selects from a codebook. A single precoder that is supposed to cover a large bandwidth (wideband precoding) may be fed back. It may also be beneficial to match the frequency variations of the channel and instead feedback a frequency-selective precoding report, e.g., several precoders, one per subband. This is an example of the more general case of channel state information (CSI) feedback, which also encompasses feeding back other information than recommended precoders to assist the network node in subsequent transmissions to the WD. Such other information may include channel quality indicators (CQIs) as well as a transmission rank indicator (RI). In NR, CSI feedback can be either wideband, where one CSI is reported for the entire channel bandwidth, or frequency-selective, where one CSI is reported for each subband, which is defined as a number of contiguous resource blocks ranging between 4-32 PRBS depending on the band width part (BWP) size.

Given the CSI feedback from the WD, the network node determines the transmission parameters it wishes to use to transmit to the WD, including the precoding matrix, transmission rank, and modulation and coding scheme (MCS). These transmission parameters may differ from the recommendations the WD makes. The transmission rank, and thus the number of spatially multiplexed layers, is reflected in the number of columns of the precoder W. For efficient performance, it is important that a transmission rank that matches the channel properties is selected.

### 2D Antenna Arrays

Some radios use two-dimensional antenna arrays. Such antenna arrays may be (partly) described by the number of antenna columns corresponding to the horizontal dimension Nₕ, the number of antenna rows corresponding to the vertical dimension Nᵥ and the number of dimensions corresponding to different polarizations Nₚ. The total number of antennas is thus N=NₕNᵥNₚ. The concept of an antenna is non-limiting in the sense that it can refer to any virtualization (e.g., linear mapping) of the physical antenna elements. For example, pairs of physical sub-elements could be fed the same signal, and hence share the same virtualized antenna port.

An example of a 4×4 array with dual-polarized antenna elements is illustrated in the example of FIG. 2.

Precoding may be interpreted as multiplying the signal with different beamforming weights for each antenna prior to transmission. A typical approach is to tailor the precoder to the antenna form factor, i.e., taking into account Nₕ,Nᵥ and Nₚ when designing the precoder codebook.

### Channel State Information Reference Signals (CSI-RS)

For CSI measurement and feedback, CSI-RS are defined. A CSI-RS is transmitted on each antenna port and is used by a WD to measure downlink channel between each of the transmit antenna ports and each of its receive antenna ports. The transmit antenna ports are also referred to as CSI-RS ports. The supported number of antenna ports in NR are {1, 2, 4, 8, 12, 16, 24, 32}. By measuring the received CSI-RS, a WD can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain resource elements (REs) in a slot and certain slots. FIG. 3 shows an example of CSI-RS REs for 12 antenna ports, where 1 RE per resource block (RB) per port is shown. In addition, an interference measurement resource (IMR) is also defined in NR for a WD to measure interference. An IMR resource contains 4 REs, either 4 adjacent REs in frequency in the same OFDM symbol or 2 by 2 adjacent REs in both time and frequency in a slot. By measuring both the channel based on non-zero power (NZP) CSI-RS and the interference based on an IMR, a WD can estimate the effective channel and noise plus interference to determine the, CSI, i.e., rank, precoding matrix, and the channel quality.

Furthermore, a WD in NR may be configured to measure interference based on one or multiple NZP CSI-RS resource.

### CSI Framework in NR

In NR, a WD can be configured with multiple CSI reporting settings and multiple CSI-RS resource settings. Each resource setting can contain multiple resource sets, and each resource set can contain up to 8 CSI-RS resources. For each CSI reporting setting, a WD feeds back a CSI report.

Each CSI reporting setting may contain at least the following information:
A CSI-RS resource set for channel measurement;
An IMR resource set for interference measurement;
Optionally, a CSI-RS resource set for interference measurement;
Time-domain behaviour, i.e. periodic, semi-persistent, or aperiodic reporting;
Frequency granularity, i.e. wideband or subband;
CSI parameters to be reported such as RI, precoder matrix indicator (PMI), channel quality indicator (CQI), and CSI-RS resource indicator (CRI) in case of multiple CSI-RS resources in a resource set;
Codebook types, i.e. type I or II, and codebook subset restriction;
Measurement restrictions; and/or
Subband size. One out of two possible subband sizes is indicated, the value range depends on the bandwidth of the bandwidth part (BWP). One CQI/PMI (if configured for subband reporting) is fed back per subband).

When the CSI-RS resource set in a CSI reporting setting contains multiple CSI-RS resources, one of the CSI-RS resources is selected by a WD and a CSI-RS resource indicator (CRI) is also reported by the WD to indicate to the network node the selected CSI-RS resource in the resource set, together with RI, PMI and CQI associated with the selected CSI-RS resource.

For aperiodic CSI reporting in NR, more than one CSI reporting setting, each with a different CSI-RS resource set for channel measurement and/or resource set for interference measurement, can be configured and triggered at the same time. In this case, multiple CSI reports are aggregated and sent from the WD to the network node in a single PUSCH.

### NR Rel-15 Type II Codebook

For the NR Type II codebook in 3GPP Release 15 (3GPP Rel-15), the precoding vector for each layer and subband is expressed in 3GPP specification 38.214 as:

$${W}_{{q}_{1} , {q}_{2} , {n}_{1} , {n}_{2} , {p}_{l}^{( 1 )} , {p}_{l}^{( 2 )} , {c}_{l}}^{l} = \frac{1}{\sqrt{{N}_{1} {N}_{2} {\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{m}_{1}^{( i )} , {m}_{2}^{( i )}} {p}_{l , i}^{( 1 )} {p}_{l , i}^{( 2 )} {φ}_{l , i} \\ {\sum }_{i = 0}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] , l = 1 , 2$$

The above formula can be restructured and expressed more simply, so that the precoder vector w_{l,p}(k) for a certain layer l=0.1, polarization p=0,1 and resource block k=0, . . . , N_{RB}−1 may be given as:

$${w}_{l , p} ( k ) = \frac{1}{C} {\sum }_{i = 0}^{L - 1} {v}_{i} {p}_{l , i}^{( 1 )} {c}_{l , i} ( k )$$

where

$${c}_{l , i} ( k ) = {p}_{l , i}^{( 2 )} ( ⌊ \frac{k}{s} ⌋ ) {φ}_{l , i} ( ⌊ \frac{k}{s} ⌋ )$$

for p=0 and

$${c}_{l , i} ( k ) = {p}_{l , L + i}^{( 2 )} ( ⌊ \frac{k}{s} ⌋ ) {φ}_{l , L + i} ( ⌊ \frac{k}{s} ⌋ )$$

for p=1, S is the subband size and N_{SB} is the number of subbands in the CSI reporting bandwidth. Hence, the change in a beam coefficient across frequency c_{l,i}(k) is determined based on the 2N_{SB} parameters p_{l,i}⁽²⁾(0), . . . , p_{l,i}⁽²⁾(N_{SB}−1) and φ_{l,i}(0), . . . , φ_{l,i}(N_{SB}−1). Where the subband amplitude parameter p_{l,i}⁽²⁾ is quantized using 0-1 bit and the subband phase parameter φ_{l,i} is quantized using 2-3 bits, depending on codebook configuration. NR 3GPP Rel-16 enhanced Type II port selection codebook. The enhanced Type II (eType II) port selection (PS) codebook was introduced in 3GPP Rel-16, which is intended to be used for beamformed CSI-RS, where each CSI-RS port covers a small portion of the cell coverage area with high beamforming gain (comparing to non-beamformed CSI-RS). Although it depends on the network node implementation, it is usually assumed that each CSI-RS port is transmitted in a two-dimensional (2D) spatial beam which has a main lobe with an azimuth pointing angle and an elevation pointing angle. The actual precoder matrix used for CSI-RS is transparent to the WD. Based on the measurement, the WD selects the best CSI-RS ports and recommends a rank, a precoding matrix, and a CQI conditioned on the rank and the precoding matrix to the network node to use for downlink (DL) transmission. The precoding matrix comprises linear combinations of the selected CSI-RS ports. The eType II PS codebook can be used by the WD to feedback the selected CSI-RS ports and the combining coefficients.
Structure, Configuration and Reporting of eType II PS Codebook

For a given transmission layer l, with l∈{1, . . . , v} and v being the rank indicated by the rank indicator (RI), the precoder matrix is given by a size P_{CSI-RS}×N₃ matrix W^{l}, where:
P_{CSI-RS} is the number of CSI-RS ports;
N₃=N_{SB}×R is the number of subbands for PMI, where:
   The value R={1,2} (the PMI subband size indicator) is RRC configured; and
   N_{SB} is the number of CQI subbands, which is also RRC configured;
The maximum RI value v is set according to the configured higher layer parameter typeII-RI-Restriction-r16. The WD may not report v>4.

For each layer l, the precoding matrix W^{l} can be factorized as W^{l}=W₁W_{2,l}W_{f,l}^{H} (see FIG. 4) and W^{l}=[w_{0,1}, w_{1,l}, . . . , w_{N}_{₃}_{-1,l}] is normalized such that ∥w_{t,l}∥_{F}=1/\sqrt{v}, for l=1, . . . , v and t=0, 1, . . . , N₃−1.

where the port selection matrix W₁ is a size P_{CSI-RS}×2 L port selection precoder matrix that can be factorized into

$${W}_{1} = [ \begin{matrix}1 & 0 \\ 0 & 1\end{matrix} ] ⊗ {W}_{PS} ,$$

where ⊗ denotes Kronecker product and

$${W}_{PS} = [ {w}_{1}^{( 0 )} … {w}_{1}^{( L - 1 )} ] is a size \frac{{P}_{CSI - RS}}{2} \times L$$

port selection matrix, where w₁⁽ⁱ⁾ of size

$$\frac{{P}_{CSI - RS}}{2} \times 1 ,$$

for i=0, 1, . . . , L−1, contains one element that indicates the selected CSI-RS port while all the other elements are 0s. L is the number of selected CSI-RS ports from each polarization and the same ports are selected for both polarizations.

Supported L values can be found in Table 1.
Selected CSI-RS ports are indicated by

$${i}_{1 , 1} ∈ \{ 0 , 1 , … , ⌈ \frac{{P}_{CSI - RS}}{2 d} ⌉ - 1 \} ,$$

which is reported by the WD to network node:
a) The value of i_{1,1} is determined by WD based on CSI-RS measurement;
b) The value of d is configured with the higher layer parameter portSelectionSamplingSize, where d∈{1, 2, 3, 4} and

$$d < min ( \frac{{P}_{CSI - RS}}{2} , L ) ;$$

W₁ is common for all layers.

Frequency-domain (FD) compression matrix W_{f,l}, having dimension N₃×M_{υ}, is the FD compression matrix for layer l, where:

$${M}_{v} = ⌈ {p}_{v} \frac{{N}_{3}}{R} ⌉$$

is the number of selected FD basis vectors, which depends on the rank indicator v and the RRC configured parameter pᵥ. Supported values of pᵥ can be found in Table 1. W_{f,l}=[w_{f,l}⁽⁰⁾ . . . w_{f,l}^{(M}^{ᵥ}⁻¹⁾], where

$${\{ {w}_{f , l}^{( k )} \}}_{k = 0}^{{M}_{v} - 1}$$

are M_{υ} FD basis vectors that are selected from N₃ orthogonal discrete Fourier transform (DFT) basis vectors {fₜ}ₜ₌₀^{N}^{₃}⁻¹ where

$${f}_{t} = {[ 1 {e}^{\frac{j 2 π t}{{N}_{3}}} , … , {e}^{\frac{j 2 π ( {N}_{3} - 1 ) t}{{N}_{3}}} ]}^{T} ,$$

(·)^{T} denotes transpose.

For N₃≤19, a one-step free selection is used.
c) For each layer, FD basis selection is indicated with a

$$⌈ {log}_{2} ( \begin{matrix}{N}_{3} - 1 \\ {M}_{v} - 1\end{matrix} ) ⌉$$

bit combinatorial indicator. In 3GPP Technical Standard (TS) 38.214, the combinatorial indicator is given by the index i_{1,6,l} where l corresponds to the layer index. This combinatorial index is reported by WD to the network node per layer. For N₃>19, a two-step selection with layer-common intermediary subset (IntS) is used:
i) In the first step, a window-based layer-common IntS selection is used, which is parameterized by Mᵢₙᵢₜᵢₐₗ. The IntS includes FD basis vectors mod(Mᵢₙᵢₜᵢₐₗ+n, N₃), where n=0, 1, . . . , N′₃−1 and N′₃=2M_{υ}. In 3GPP TS 38.214, the selected IntS is reported by the WD to the network node via the parameter i_{1,5}, which is reported per layer as part of the PMI reported;
ii) The second step subset selection is indicated by an

$$⌈ {log}_{2} ( \begin{matrix}{N}_{3}^{′} - 1 \\ {M}_{v} - 1\end{matrix} ) ⌉$$

-bit combinatorial indicator for each layer. In TS 38.214, the combinatorial indicator is given by the index i_{1,6,l} where l corresponds to the layer index. This combinatorial index is reported by WD to the network node per layer. W_{f,l} is layer-specific.

### Linear Combination Coefficient Matrix W_{2,l}:

is a size 2 L×M_{υ} matrix that contains 2 LM_{υ} coefficients for linearly combining the selected M_{υ} FD basis vectors and the selected 2 L CSI-RS ports;
For layer l, only a subset of Kₗ^{NZ}≤K₀ coefficients are non-zero and reported. The remaining 2 LM_{υ}−Kₗ^{NZ} non-reported coefficients are considered zero:
   K₀=[β×2 LM₁] is the maximum number of non-zero coefficients per layer, where β is a radio resource control (RRC) configured parameter. Supported β values are shown in Table 1;
   For v∈{2, 3, 4}, the total number of non-zero coefficients summed across all layers, Kₜₒₜ^{NZ}=Σₗ₌₁^{v}Kₗ^{NZ}, may satisfy Kₜₒₜ^{NZ}≤2K₀;
   Selected coefficient subset for each layer is indicated with Kₗ^{NZ} is in a size 2 LM_{υ} bitmap, i_{1,7,l}; and/or
   The selected CSI-RS port associated with the strongest coefficient of layer l is identified by i_{1,8,l},∈{0,1, . . . ,2 L−1};
The amplitude coefficients in W_{2,l} are indicated by i_{2,3,l} and i_{2,4,l}, and the phase coefficients in W_{2,l} are indicated by i_{2,5,l}; and/pr
W_{2,l} is layer-specific.

TABLE 1
3GPP Rel-16 Type II PS codebook parameter
configurations for L, pᵥ and β

| | | p_{υ} | | |
|---|---|---|---|---|
| paramCombination-r16 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |

The PMI reported by the WD comprises codebook indices i₁ and i₂ where:

$${i}_{1} = \{ \begin{matrix}[ {i}_{1 , 1} {i}_{1 , 5} {i}_{1 , 6 , 1} {i}_{1 , 7 , 1} {i}_{1 , 8 , 1} ] & υ = 1 \\ [ {i}_{1 , 1} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} ] & υ = 2 \\ [ {i}_{1 , 1} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} ] & υ = 3 \\ [ {i}_{1 , 1} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} {i}_{1 , 6 , 4} {i}_{1 , 7 , 4} {i}_{1 , 8 , 4} ] & υ = 4\end{matrix}$$

$${i}_{2} = \{ \begin{matrix}[ {i}_{2 , 3 , 1} {i}_{2 , 4 , 1} {i}_{2 , 5 , 1} ] & υ = 1 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} ] & υ = 2 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} ] & υ = 3 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} {i}_{2 , 3 , 4} {i}_{2 , 4 , 4} {i}_{2 , 5 , 4} ] & υ = 4\end{matrix}$$

The precoding matrix is the PMI values according to Table 2.

TABLE 2
Precoding matrix indicated by PMI.

| Numbers | Precoding Matrix for PMI subband t ∈ |
|---|---|
| of layers | (0, 1, ... , N₃) |
| v = 1 | Wₜ^{(v=1)} = w_{1,t} |
| v = 2 | Wₜ^{(v=2)} = [w_{1,t} w_{2,t}] |
| v = 3 | Wₜ^{(v=3)} = [w_{1,t} w_{2,t} w_{3,t}] |
| v = 4 | Wₜ^{(v=4)} = [w_{1,t} w_{2,t} w_{3,t} w_{4,t}] |

${w}_{l , t} = \frac{1}{\sqrt[2]{v}} \frac{1}{\sqrt[2]{{γ}_{t , l}}} [ \begin{matrix}{\sum }_{i = 0}^{L - 1} {ν}_{{i}_{1 , 1} d + i} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {ν}_{{i}_{1 , 1} d + i} {p}_{l , 1}^{( 1 )} {\sum }_{f = 0}^{{M}_{v} - 1} {y}_{t , l}^{( f )} {p}_{l , i + L , f}^{( 2 )} {φ}_{l , i + L , f}\end{matrix} ] ,$ $l = 1 , 2 , 3 , 4 ; t = 0 , 1 , … , {N}_{3} - 1 .$
${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{v} - 1} {y}_{t , l}^{( f )} {p}_{l , i , f}^{( 2 )} {φ}_{l , i , f} \vert}^{2}$
vₘ is a P_{CSI-RS}/2 -element column vector containing a value of 1 in
element (m mod P_{CSI-RS}/2) and zeros elsewhere
${y}_{t , l}^{( f )} = {e}^{j \frac{2 π t {n}_{3 , l}^{( f )}}{{N}_{3}}} , t = 0 , 1 , … , {N}_{3} - 1 ; f = 0 , 1 , … , {M}_{v} - 1 ; l = 1 , 2 , 3 , 4.$
n_{3,l}^{(f)} ∈ (0,1, ... , N₃ − 1) is derived from i_{1,6,1} and if N₃ > 19, i_{1,5}
p_{l,p}⁽¹⁾ ∈ (0,1) is a wideband amplitude coefficient indicated by i_{2,3,l}
P_{l,i,f}⁽²⁾ is a subband amplitude coefficient indicated by i_{2,4,l}
${φ}_{l , i , f} = {e}^{j \frac{2 π {c}_{l , i , f}}{16}} , {c}_{l , i , f} ∈ \{ 0 , … , 15 \} is phase coefficient indicated by {i}_{2 , 5 , l}$

For 3GPP Rel-16 Enhanced Type II CSI feedback, a CSI report includes two parts. Part 1 has a fixed payload size and is used to identify the number of information bits in Part 2. Part 1 contains RI, CQI, and an indication of the overall number of non-zero amplitude coefficients across layers, i.e., Kₜₒₜ^{NZ}∈{1, 2, . . . , 2K₀}. Part 2 contains the PMI. Part 1 and 2 are separately encoded.

### FDD-Based Reciprocity Operation and 3GPP Rel-17 Type II Port Selection Codebook

In frequency division duplex (FDD) operation, the uplink (UL) and downlink (DL) transmissions are carried out on different frequencies. Thus the propagation channels in UL and DL are not reciprocal as in the time division duplex (TDD) case. Despite of this, some physical channel parameters, e.g., delays and angles to different clusters, which depend on the spatial properties of the channel but not the carrier frequency, are reciprocal between UL and DL. Such properties can be exploited to obtain partial reciprocity based FDD transmission. The reciprocal part of the channel can be combined with the non-reciprocal part in order to obtain the complete channel. An estimate of the non-reciprocal part can be obtained by feedback from the WD. In 3GPP RAN1, it has been considered that in 3GPP Rel-17, the 3GPP Rel-16 Type II port selection codebook will be enhanced to support the above the above-mentioned FDD-based reciprocity operation. It has been considered in 3GPP RAN1 #104e that the 3GPP Rel-17 Type II port selection codebook will adopt the same codebook structure as the 3GPP Rel-16 Type II port selection codebook, i.e., the codebook includes W₁, W₂ and W_{f}. Consideration of the details of the codebook component, such as dimension of each matrix, is still ongoing.

### Procedure for FDD-Based Reciprocity Operation

One example procedure for reciprocity based FDD transmission scheme is illustrated in FIG. 5 in 4 steps, assuming that NR 3GPP Rel.16 enhanced Type II port-selection codebook is used.

In Step 1, the WD is configured with a sounding reference signal (SRS) by the network node and the WD transmits a sounding reference signal (SRS) in the UL for the network node to estimate the angles and delays of different clusters, which are associated with different propagation paths.

In Step 2, in the network node implementation algorithm, the network selects dominant clusters according to the estimated angle-delay power spectrum profile, based on which a set of spatial-domain and frequency-domain (SD-FD) basis pairs are computed by the network node for CSI-RS beamforming. Each SD-FD pair corresponds to a CSI-RS port with certain delay being pre-compensated. Each CSI-RS port resource can contain one or multiple SD-FD basis pairs by applying different delays on different resource elements of the resource. The network node precodes all the CSI-RS ports in a configured CSI-RS resource or multiple CSI-RS resources to the WD, with each configured CSI-RS resource containing the same number of SD-FD basis pairs.

In Step 3, the network node has configured the WD to measure CSI-RS, and the WD measures the received CSI-RS ports and then determines a type II CSI including RI, PMI for each layer and CQI. The precoding matrix indicated by the PMI includes the selected SD-FD basis pairs/precoded CSI-RS ports, and the corresponding best phase and amplitude for co-phasing the selected pairs/ports. The phase and amplitude for each pair/port are quantized and fed back to the network node.

In Step 4, the network node implementation algorithm computes the DL precoding matrix per layer based on the selected beams and the corresponding amplitude and phase feedback and performs PDSCH transmission. The transmission is based on the feed-back (PMI) precoding matrices directly (e.g., single user (SU)-MIMO transmission) or the transmission precoding matrix is obtained from an algorithm combining CSI feedback from multiple WDs (MU-MIMO transmission). In this case, a precoder derived based on the precoding matrices (including the CSI reports from co-scheduled WDs) (e.g., Zero-Forcing (ZF) precoder or regularized ZF precoder). The final precoder is commonly scaled so that the transmit power per power amplifier is not overridden.

Such reciprocity-based transmission can potentially be utilized in a codebook-based DL transmission for FDD in order to, for example, reduce the feedback overhead in UL when NR Type II port-selection codebook is used. Another potential benefit is reduced complexity in the CSI calculation in the WD. Note that FIG. 5 only sketches one example of the procedure for FDD-based reciprocity operation, where each CSI-RS port contains a single pair of SD-FD basis and the WD performs wideband averaging of the channel to obtain the corresponding coefficients. It is possible that each CSI-RS port contains multiple pairs of SD-FD basis and that the WD can compress the channel with more FD components besides the DC DFT component.

### Type II Port Selection Codebook for FDD Operation Based on Angle and Delay Reciprocity

If the 3GPP Rel-16 enhanced Type II port-selection codebook is used for FDD operation based on angle and/or delay reciprocity, the frequency-domain (FD) basis W_{f} still needs to be determined by the WD. Therefore, in the CSI report, the feedback overhead for indicating which FD basis vectors are selected can be large, especially when N₃, the number of PMI subbands, is large. Also, the computational complexity at the WD for evaluating and selecting the best FD basis vectors also increases as N₃ increases. In addition, the channel seen at the WD is frequency-selective, which requires a number of FD basis vectors to compress in the PMI report. Reporting coefficients to these FD basis vectors also consumes a large amount of UL overhead.

Based on the angle and delay reciprocity, as mentioned above, the network node can determine a set of dominant clusters in the propagation channel by analyzing the angle-delay power spectrum of the UL channel. Then, the network node can utilize this information in a way such that each CSI-RS port is precoded towards a dominant cluster. In addition to SD beamforming, each of the CSI-RS ports will also be pre-compensated in time such that all the precoded CSI-RS ports are aligned in delay domain. As a result, frequency-selectivity of the channel is removed and the WD observes a frequency-flat channel, which requires very small number of FD basis to compress. Ideally, if all the beams can be perfectly aligned in time, the WD only needs to do a wideband filtering to obtain all the channel information, based on which the WD can calculate the 3GPP Rel-17 Type II PMI. Even if delay cannot be perfectly pre-compensated at the network node in reality, the frequency selectively seen at the WD can still be greatly reduced, so that the WD only requires a much smaller number of frequency domain (FD) basis vectors, i.e., the number of basis vectors in W_{f}, to compress the channel.

The above procedure is further explained in the example of FIG. 6. Based on UL measurements, the network node identifies 8 dominant clusters that exist in the original channel, tagged as A-G, which are distributed in 4 directions, with each direction containing one or multiple taps. In this example, 8 CSI-RS ports are precoded at the network node. Each CSI-RS port is precoded towards a dominant direction with pre-compensated delay for a given clusters. The delay compensation can be realized in different ways, for instance by applying a linear phase slope across occupied subcarriers. As a result, in the beamformed channel, which is seen at the WD, all the dominant clusters are aligned at the same delay. Hence the WD only needs to apply a wideband filter. This can be done, for example, by applying the DC component of a DFT matrix, i.e., W_{f} containing a single vector of all ones over a frequency domain channel to compress the channel and preserve all the channel information. Based on the compressed channel, the WD calculates W₁ (selected CSI-RS ports) and W₂ (complex coefficients for combining selected ports), which are the remaining part of the Type II port selection codebook. FIG. 7 is another example of precoding.

Although consideration of the 3GPP Rel-17 Type II codebook is still ongoing, the 3GPP Rel-16 Type II codebook structure has been confirmed to be reused for 3GPP Rel-17, i.e., the 3GPP Rel-17 also comprises of W₁, W₂ and W_{f}. One potential difference between a 3GPP Rel-17 codebook and the 3GPP Rel-16 Type II codebook is that W_{f} might be layer-common. The structure of W₁, W₂ will remain the same as in 3GPP Rel-16 Type II.

### Type II CSI Report on PUSCH

A WD may perform aperiodic CSI reporting using PUSCH upon successful decoding of a downlink control information (DCI) format 0_1 or DCI format 0_2 which triggers an aperiodic CSI trigger state.

When a DCI format 0_1 schedules two PUSCH allocations, the aperiodic CSI report is carried on the second scheduled PUSCH. When a DCI format 0_1 schedules more than two PUSCH allocations, the aperiodic CSI report is carried on the penultimate scheduled PUSCH.

A WD may perform semi-persistent CSI reporting on the PUSCH upon successful decoding of a DCI format 0_1 or DCI format 0_2 which activates a semi-persistent CSI trigger state. DCI format 0_1 and DCI format 0_2 contains a CSI request field which indicates the semi-persistent CSI trigger state to activate or deactivate. The PUSCH resources and MCS may be allocated semi-persistently by an uplink DCI.

CSI reporting on PUSCH can be multiplexed with uplink data on PUSCH. CSI reporting on PUSCH can also be performed without any multiplexing with uplink data from the WD.

### Part 1 and Part 2 for Type II CSI Report

For the 3GPP Rel-15 Type II and the 3GPP Rel-16 Type II (aka Enhanced Type II, or eType II) CSI feedback on PUSCH, a CSI report comprises of two parts: Part 1 and Part 2. A main motivation for dividing a CSI report into Part 1 and Part 2 is to deal with the dynamically varying CSI payload. For example, based on the time-varying channel, the WD may report different ranks over the whole period of connection, which has significant impact on the actual required CSI payload size. In order for the network node to know the actual payload size, Part 1, which has a fixed payload size that carries the information to calculate the payload size of Part 2, will be decoded first by the network node.

For the 3GPP Rel-15 Type II CSI feedback, Part 1 contains rank information (RI) (if reported), channel quality indicator (CQI), and an indication of the number of non-zero wideband amplitude coefficients per layer for the Type II CSI (see Clause 5.2.2.2.3 in 3GPP TS 38.214). The fields of Part 1—RI (if reported), CQI, and the indication of the number of non-zero wideband amplitude coefficients for each layer—are separately encoded. Part 2 contains the PMI of the Type II CSI. Part 1 and 2 are separately encoded.

For the 3GPP Rel-16 Type II CSI feedback, Part 1 contains RI, CQI, and an indication of the overall number of non-zero amplitude coefficients across layers for the 3GPP Rel-16 Type II CSI (see Clause 5.2.2.2.5 in 3GPP TS 38.214). The fields of Part 1—RI, CQI, and the indication of the overall number of non-zero amplitude coefficients across layers—are separately encoded. Part 2 contains the PMI of the Enhanced Type II CSI. Part 1 and 2 are separately encoded.

### UCI Omission Procedure for Type II CSI Report

Because there can be a large discrepancy between the PMI payload for different selection of RI by the WD for Type II CSI reporting, it is possible that the PUSCH resource allocation for carrying the CSI report does not fit the entire CSI content. For instance, the rank-2 PMI payload is almost 2× the rank-1 PMI payload for the 3GPP Rel-15/3GPP Rel-16 Type II codebook. And since the RI is dynamically selected by the WD, the network node cannot entirely predict the PMI payload before scheduling the CSI report and hence the resource allocation may be too small. That is, the network node may have scheduled a resource appropriate for a rank-1 PMI report (due to e.g. that the WD lately have been reporting RI=1) but the WD reports rank-2 PMI, which will not fit in the allocated PUSCH resource.

To remedy this case, CSI omission procedures have been specified in 3GPP, where a portion of CSI Part 2 can be omitted if the resulting uplink control information (UCI) code rate is too low (Part 1 cannot be omitted as it is needed to correctly decode Part 2). This is achieved by segmenting the CSI Part 2 payload into different priority levels, and dropping CSI segment starting with the lowest priority level until the UCI code rate falls below a threshold (whereby the CSI payload will “fit” on the PUSCH allocation). The priority levels for both 3GPP Rel-15 and 3GPP Rel-16 Type II are described in Table 3 (Table 5.2.3-1 in 3GPP TS 38.214 V16.0.0), where Priority 0 has the highest priority and N_Rep represents the number of CSI reports. The CSI omission procedure is explained in more detail below.

TABLE 3
Priority reporting levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report
N_{Rep}, if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

### 3GPP Rel-15 Type II CSI Omission:

For 3GPP Rel-15 Type II, CSI Part 2 is divided into a wideband PMI part and a subband PMI part. The wideband part carries information such as spatial domain (SD) basis indication including rotation factor (for regular Type II) or port indication (for port-selection Type II), wideband amplitude coefficients per layer and strongest coefficient indicator (SCI) per layer. The subband part carries information such as subband amplitude and phase.

The subband PMI is the most payload heavy since it is reported independently for each subband (whereas the wideband PMI is only reported once for the entire CSI reporting band). In the described CSI omission procedure, subband PMI for odd and even numbered subbands are respectively grouped into different CSI segments with different priority. This implies that if the PUSCH resource allocation is too small to fit the CSI payload, the subband PMI for the odd subbands can be dropped and only subband PMI for even subbands are reported.

The motivation behind this design is that the reported remaining PMI can still be used by the network node. Since the network node has knowledge of the subband PMI for every other subband, it can perform interpolation between subbands to estimate the PMI for the omitted subbands. Due to that the subband PMIs are correlated in frequency, the performance loss may not be that severe.

### 3GPP Rel-16 Type II CSI Omission:

For 3GPP Rel-16 Type II, CSI Part 2 is segmented into three groups:
Group 0: SD basis indication including rotation factor (for 3GPP Rel-16 regular Type II) or port indication (for 3GPP Rel-16 port-selection Type II), SCI for each layer;
Group 1: frequency domain (FD) basis indication for each layer, wideband (polarization) reference amplitude, part of the bitmap and amplitude and phase for subband coefficients with the highest priority; and
Group 2: the remaining part of bitmap and amplitude and phase for subband coefficients with the lowest priority.

For each reported element of bitmap, subband amplitude and phase in Group 1 and 2, a priority level is determined via the value of the following priority function, indexed by l,i,f:

$$Pri ( l , i , f ) = 2 \cdot L \cdot υ \cdot π ( f ) + υ \cdot i + l ,$$

with π(f)=min (2·n_{3,l}^{(f)}, 2·(N₃−n_{3,l}^{(f)})−1) with l=1,2, . . . , v being the layer index and v being the RI, i=0,1, . . . ,2 L−1 being the index of selected ports, f=0,1, . . . , M_{υ}−1 being the index of selected FD basis vectors and M_{υ} being the number of selected FD basis vectors for each layer, and n∈{0, 1, . . . , N₃−1} being the index of FD basis vectors from which the WD can select, and N₃ is the number of PMI subbands. The element with the highest priority has the lowest associated value Pri(l, i, f).

The motivation behind the way grouping is done is that the network node should still be able to recover part of the CSI even if some low priority groups are omitted. For example, if Group 1 and 2 are omitted, the PMI feedback in Group 0 is essentially a Type I PMI, the network node can still schedule SU-MIMO based on that CSI report. In another example, if Group 2 is omitted, information of selected SD and FD basis vectors is still complete, only part of the combination coefficients are omitted. However, since the combination coefficients are reported and omitted in a predictable manner based on the pre-defined priority function, the network node is still aware of the association between the reported coefficients and the SD and FD basis vector. Thus, DL channel can still be partly obtained via the incomplete CSI report.

Since the payload of 3GPP Rel-17 Type II CSI heavily depends on the reported rank, a robust CSI omission procedure is necessary for the 3GPP Rel-17 Type II to work even if part of the CSI report is omitted. Reusing the 3GPP Rel-16 Type TT CSI omission rules, including CSI grouping and priority handling, may not work if 3GPP Rel-17 Type II is configured. For example, if Group 1 and Group 2 CSI are omitted according to 3GPP Rel-16 Type II CSI omission rules, the network node cannot reconstruct the DL channel based on only CSI Group 0, as the essential information of selected FD basis is lost.

### SUMMARY

Some embodiments advantageously provide methods, network nodes and wireless devices for channel state information (CSI) omission for type II CSI. Some embodiments provide a set of solutions for robust CSI omission procedure, including CSI content grouping and priority handling, for 3GPP Rel-17 Type II, including one or more of the following examples:
Methods/arrangements to determine the group location that indicates the selected FD basis based on CSI report configuration;
Methods/arrangements for priority handling in the priority function;
Methods/arrangements for grouping the Part 2 CSI.

According to one aspect, a method in a network node configured to communicate with a wireless device, WD includes receiving from the WD an indication of a channel state information, CSI, reporting capability for a codebook based CSI comprising information of at least one frequency domain, FD, basis vector. The method also includes configuring the WD to report the codebook based CSI in multiple CSI reporting groups with different priorities, the FD basis vector information being associated with CSI in a CSI reporting Group having a highest priority among the multiple CSI reporting groups.

According to this aspect, in some embodiments, a codebook of the codebook based CSI is a port selection codebook and the CSI further comprises indices of multiple selected CSI reference signal, CSI-RS, ports. In some embodiments, the port selection codebook is an enhanced type II port selection codebook defined in 3GPP New Radio Technical Release 17 and the WD is configured to report the FD basis vector information in CSI reporting Group 0. In some embodiments, the FD basis vector information includes an index indicating a set of selected FD basis vectors. In some embodiments, the CSI further includes information of a plurality of layers and the FD basis vector information includes FD basis vector information for each layer of the plurality of layers. In some embodiments, the plurality of layers, a plurality of ports and the FD basis vectors are prioritized from highest to lowest in an order of FD basis vectors, ports and then layers. In some embodiments, the CSI further comprises a set of non-zero subband coefficients and an associated non-zero bitmap for each layer, at least one of the non-zero subband coefficients and bits of the bitmap associated with an FD basis vector having a smallest index being assigned a highest priority. In some embodiments, each of the non-zero subband coefficients comprises an amplitude and phase. In some embodiments, at least one of the non-zero bitmap and the non-zero subband coefficients for all layers are reported in a same CSI reporting group. In some embodiments, the non-zero bitmap and the set of non-zero subband coefficients for each of the plurality of layers are reported in a different CSI reporting group. In some embodiments, the non-zero bitmap for a set of non-zero subband coefficients and the set of non-zero subband coefficients are reported in one of CSI reporting Group 1 and 0 based at least in part on a priority.

According to another aspect, a network node configured to communicate with a wireless device, WD, includes a radio interface configured to receive from the WD (22) an indication of a channel state information, CSI, reporting capability for a codebook based CSI comprising information of at least one frequency domain, FD, basis vector. The radio interface is also configured to configure the WD to report the codebook based CSI in multiple CSI reporting groups with different priorities, the FD basis vector information being associated with CSI in a CSI reporting Group having the highest priority among the multiple CSI reporting groups.

According to this aspect, in some embodiments, a codebook of the codebook based CSI is a port selection codebook and the CSI further comprises indices of multiple selected CSI reference signal, CSI-RS, ports. In some embodiments, the port selection codebook is an enhanced type II port selection codebook defined in 3GPP New Radio Technical Release 17 and the WD is configured to report the FD basis vector information in CSI reporting Group 0. In some embodiments, the FD basis vector information includes an index indicating a set of selected FD basis vectors. In some embodiments, the CSI further includes information of a plurality of layers and the FD basis vector information includes FD basis vector information for each layer of the plurality of layers. In some embodiments, the layers, a plurality of ports and the FD basis vectors are prioritized from highest to lowest in an order of FD basis vectors, ports and then layers. In some embodiments, the CSI further comprises a set of non-zero subband coefficients and an associated non-zero bitmap for each layer, at least one of the non-zero subband coefficients and bits of the bitmap associated with an FD basis vector having a smallest index being assigned a highest priority. In some embodiments, each of the non-zero subband coefficients comprises an amplitude and phase. In some embodiments, at least one of the non-zero bitmap and the set of non-zero subband coefficients for all layers are reported in a same CSI reporting group. In some embodiments, the non-zero bitmap and the non-zero subband coefficients for each of the plurality of layers are reported in a different CSI reporting group. In some embodiments, the non-zero bitmap for a set of non-zero subband coefficients and the set of non-zero subband coefficients are reported in one of CSI reporting Group 1 and 0 based at least in part on a priority.

According to yet another aspect, a method in a wireless device, WD, configured to communicate with a network node, includes: receiving a configuration for reporting codebook based channel state information, CSI, comprising frequency domain, FD, basis vector information; and reporting the codebook based CSI in multiple CSI reporting groups with different priorities, the FD basis vector information being included in a CSI reporting Group having a highest priority among the multiple reporting groups.

According to this aspect, in some embodiments, the method includes reporting the FD basis vector information in CSI reporting Group 1 for a Type II port selection codebook defined in Third Generation Partnership Project Technical Release 16, 3GPP Rel-16, and reporting the FD basis vector information in CSI reporting Group 0 for a Type II port selection codebook defined in 3GPP Technical Release 17, 3GPP Rel-17. In some embodiments, the FD basis vector information includes an index indicating a set of selected FD basis vectors. In some embodiments, the codebook CSI further includes information of a plurality of layers and the FD basis vector information includes FD basis vector information for each layer of the plurality of layers. In some embodiments, the layers, a plurality of ports and the FD bases vectors are prioritized from highest to lowest in an order of FD basis, ports and then layers. In some embodiments, at least one of a non-zero bitmap and subband coefficients for all layers are reported in a same CSI reporting group. In some embodiments, at least one of a bitmap and a subband amplitude and phase for each of a plurality of subsets of layers are reported in a different CSI reporting group. In some embodiments, a non-zero bitmap for a set of non-zero subband coefficients and the set of non-zero subband coefficients are reported in one of CSI reporting Group 1 and 0 based at least in part on a priority.

According to another aspect, a wireless device, WD, configured to communicate with a network node, includes a radio interface configured to: receive a configuration for reporting codebook based channel state information, CSI, comprising frequency domain, FD, basis vector information; and report the codebook based CSI in multiple CSI reporting groups with different priorities, the FD basis vector information being included in a CSI reporting Group having a highest priority among the multiple reporting groups.

According to this aspect, in some embodiments, the reporting includes reporting the FD basis vector information in CSI reporting Group 1 for a Type II port selection codebook defined in Third Generation Partnership Project Technical Release 16, 3GPP Rel-16, and reporting the FD basis vector information in CSI reporting Group 0 for a Type II port selection codebook defined in 3GPP Technical Release 17, 3GPP Rel-17. In some embodiments, the FD basis vector information includes an index indicating a set of selected FD basis vectors. In some embodiments, the codebook CSI further includes information of a plurality of layers and the FD basis vector information includes FD basis vector information for each layer of the plurality of layers. In some embodiments, the layers, a plurality of ports and the FD bases vectors are prioritized from highest to lowest in an order of FD basis, ports and then layers. In some embodiments, at least one of a non-zero bitmap and subband coefficients for all layers are reported in a same CSI reporting group. In some embodiments, at least one of a bitmap and a subband amplitude and phase for each of a plurality of subsets of layers are reported in a different CSI reporting group. In some embodiments, a non-zero bitmap for a set of non-zero subband coefficients and the set of non-zero subband coefficients are reported in one of CSI reporting Group 1 and 0 based at least in part on a priority.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a transmission structure of precoded spatial multiplexing;

FIG. 2 is an illustration representing a two-dimensional array;

FIG. 3 is an example of resource element allocation;

FIG. 4 is a factorization of a Type II port selection precoder;

FIG. 5 illustrates a procedure for codebook based transmission;

FIG. 6 is an example of CSI-RS precoding;

FIG. 7 is a schematic diagram of an exemplary network architecture illustrating a communication system connected via an intermediate network to a host computer according to the principles in the present disclosure;

FIG. 8 is a block diagram of a host computer communicating via a network node with a wireless device over an at least partially wireless connection according to some embodiments of the present disclosure;

FIG. 9 is a flowchart illustrating exemplary methods implemented in a communication system including a host computer, a network node and a wireless device for executing a client application at a wireless device according to some embodiments of the present disclosure;

FIG. 10 is a flowchart illustrating exemplary methods implemented in a communication system including a host computer, a network node and a wireless device for receiving user data at a wireless device according to some embodiments of the present disclosure;

FIG. 11 is a flowchart illustrating exemplary methods implemented in a communication system including a host computer, a network node and a wireless device for receiving user data from the wireless device at a host computer according to some embodiments of the present disclosure;

FIG. 12 is a flowchart illustrating exemplary methods implemented in a communication system including a host computer, a network node and a wireless device for receiving user data at a host computer according to some embodiments of the present disclosure;

FIG. 13 is a flowchart of an exemplary process in a network node for channel state information (CSI) omission for type II CSI;

FIG. 14 is a flowchart of an exemplary process in a wireless device for channel state information (CSI) omission for type II CSI;

FIG. 15 is a flowchart of another exemplary process in a network node for channel state information (CSI) omission for type II CSI;

FIG. 16 is a flowchart of another exemplary process in a wireless device for channel state information (CSI) omission for type II CSI; and

FIG. 17 is an example of CSI-RS precoding according to principles set forth herein;

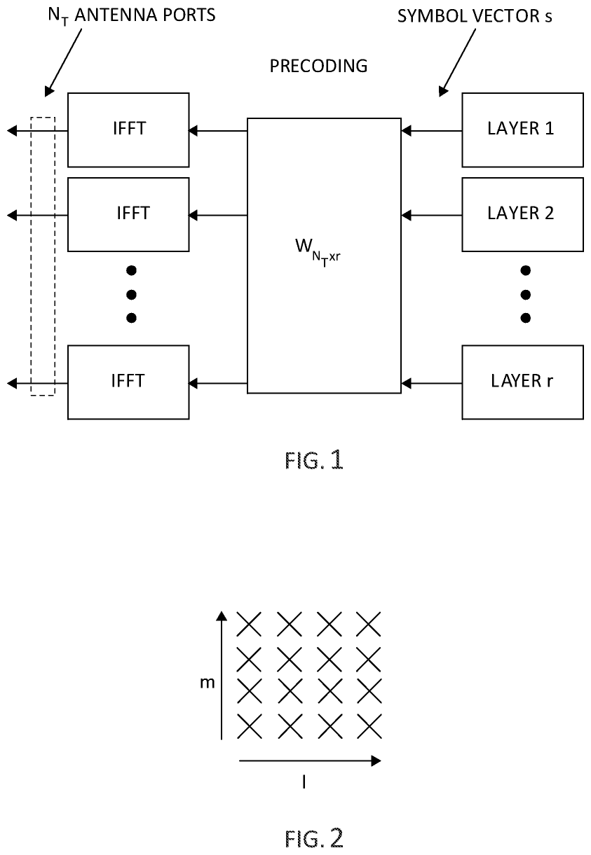

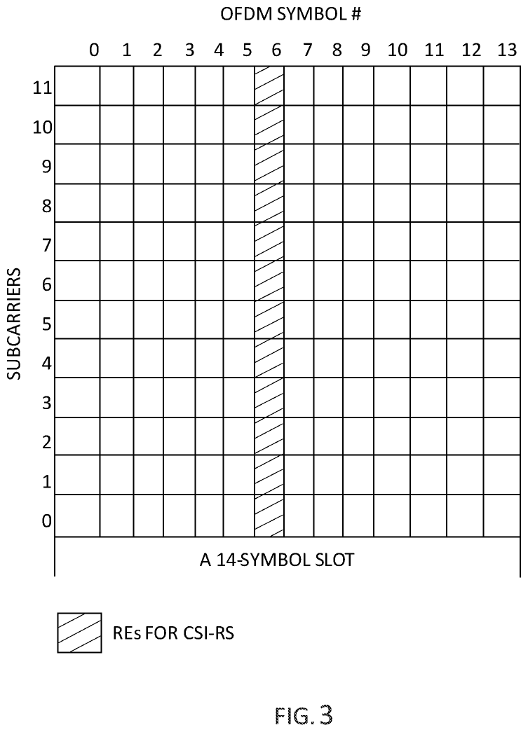

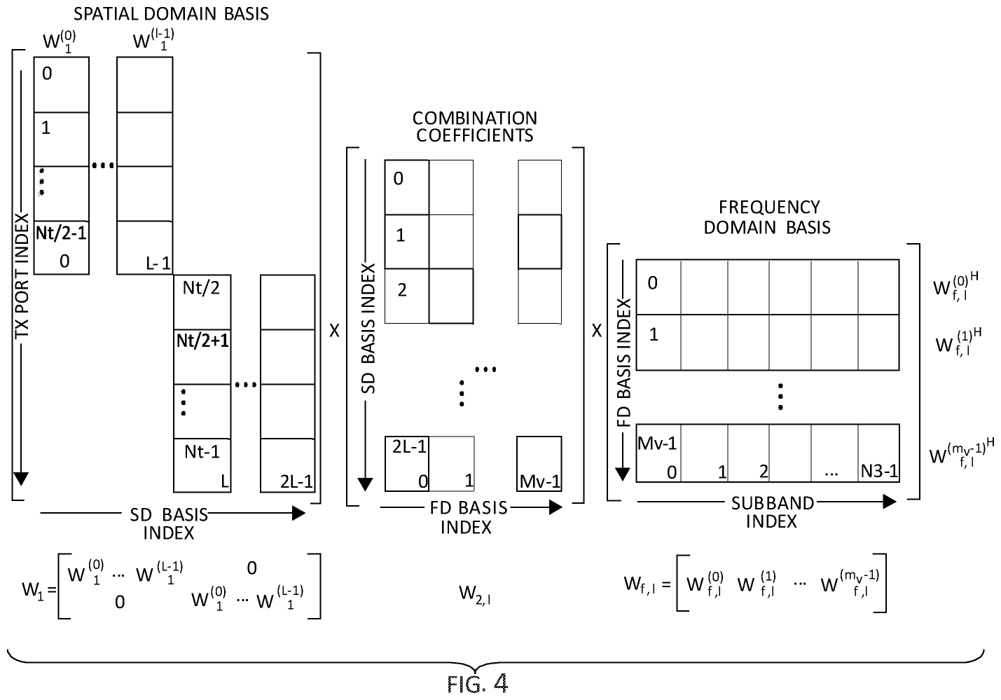

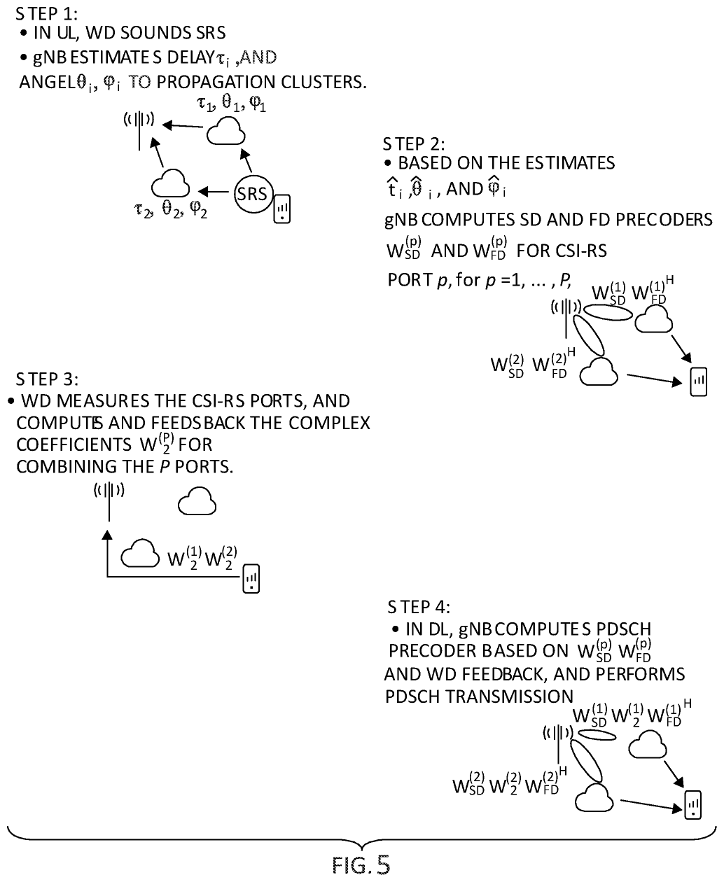

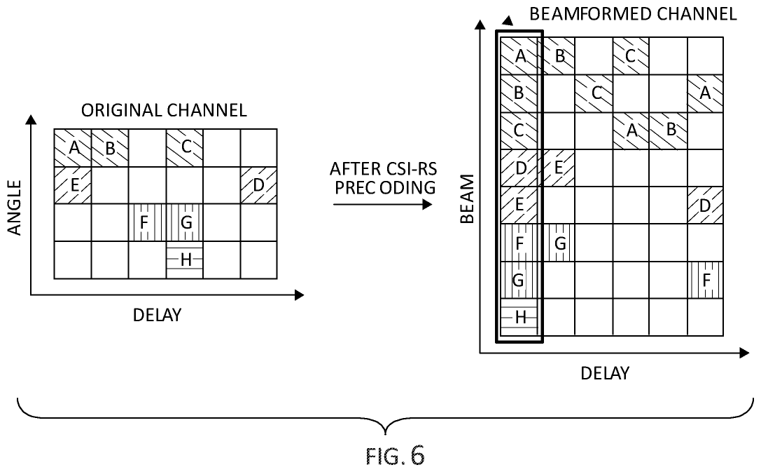

### DETAILED DESCRIPTION

Before describing in detail exemplary embodiments, it is noted that the embodiments reside primarily in combinations of apparatus components and processing steps related to channel state information (CSI) omission for type II CSI. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signalling, infrared signalling or optical signalling, for example. One having ordinary skill in the art will appreciate that multiple components may interoperate, and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMAX), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide robust CSI omission procedure for 3GPP Rel-17 Type II CSI report. It is also noted that the term transmission and reception point (TRP) may not be used in 3GPP specifications. Instead, a TRP may be represented by a transmission configuration indication (TCI) state, a non-zero power (NZP) CSI-RS resource, or a subset of ports within an NZP CSI-RS resource.

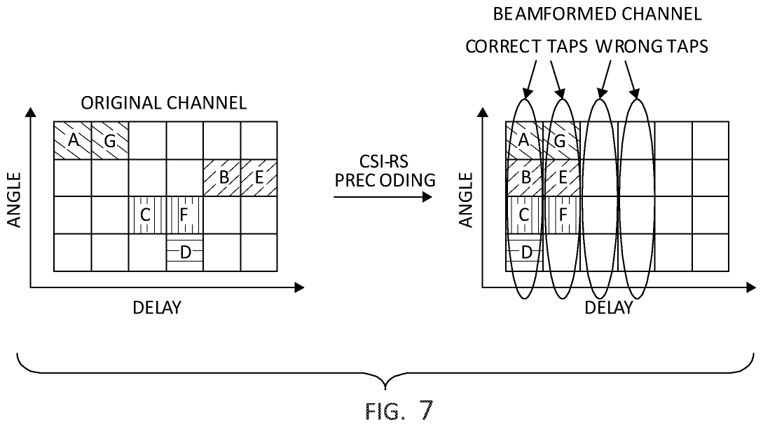

Referring again to the drawing figures, in which like elements are referred to by like reference numerals, there is shown in FIG. 7 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 7 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signalling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to configure the WD to report the codebook based CSI in multiple CSI reporting groups with different priorities, the FD basis vector information being associated with CSI in a CSI reporting Group having the highest priority among the multiple CSI reporting groups. A wireless device 22 is configured to include a priority unit 34 which is configured to report the codebook based CSI in multiple CSI reporting groups with different priorities, the FD basis vector information being included in a CSI reporting Group having a highest priority among the multiple reporting groups.

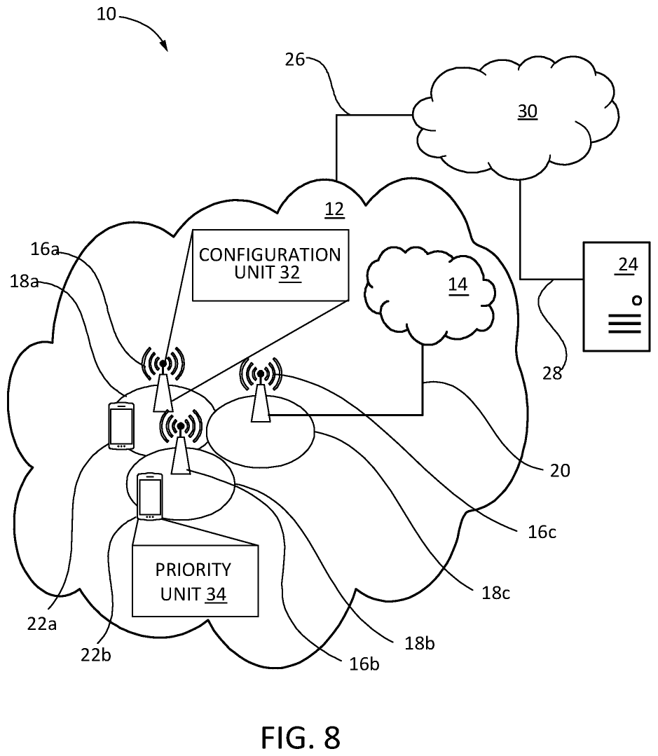

Example implementations, in accordance with an embodiment, of the WD 22, network node 16 and host computer 24 discussed in the preceding paragraphs will now be described with reference to FIG. 8. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which is configured to configure the WD to report the codebook based CSI in multiple CSI reporting groups with different priorities, the FD basis vector information being associated with CSI in a CSI reporting Group having the highest priority among the multiple CSI reporting groups.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a priority unit 34 which is configured to report the codebook based CSI in multiple CSI reporting groups with different priorities, the FD basis vector information being included in a CSI reporting Group having a highest priority among the multiple reporting groups. The processing circuitry 84 may further be configured to report to the network node at least one of a: a group location for indicating a set of frequency domain, FD, basis vectors; a priority ordering for reporting elements of indices representing at least one of subband amplitude, a subband phase, and a bitmap for non-zero coefficients; and a group location for indicating at least one of the bitmap for non-zero coefficients, subband amplitude and phase coefficients.

In some embodiments, the inner workings of the network node 16, WD 22, and host computer 24 may be as shown in FIG. 8 and independently, the surrounding network topology may be that of FIG. 7.

In FIG. 8, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signalling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 7 and 8 show various “units” such as configuration unit 32, and priority unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

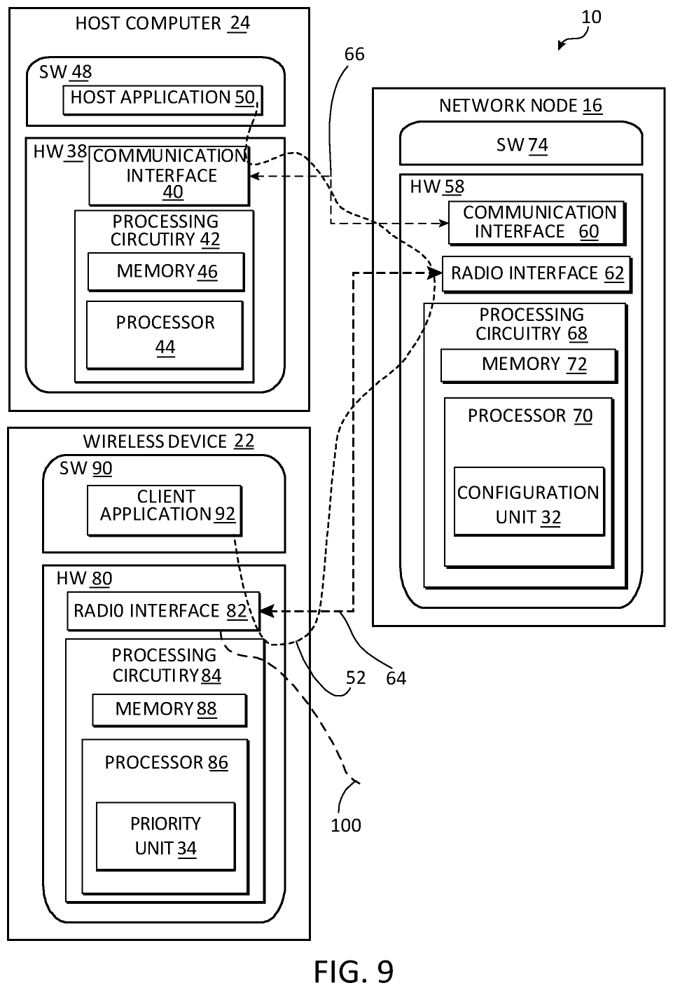

FIG. 9 is a flowchart illustrating an exemplary method implemented in a communication system, such as, for example, the communication system of FIGS. 7 and 8, in accordance with one embodiment. The communication system may include a host computer 24, a network node 16 and a WD 22, which may be those described with reference to FIG. 8. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

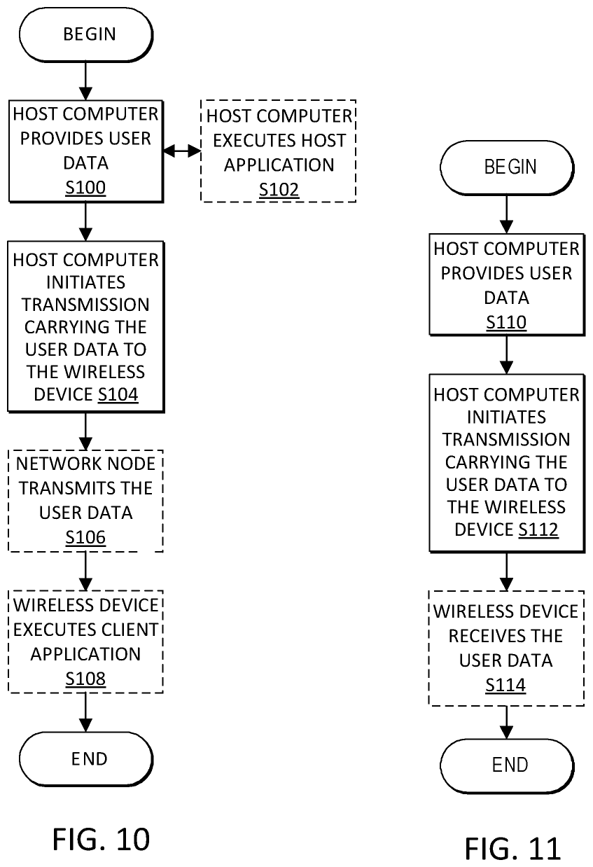

FIG. 10 is a flowchart illustrating an exemplary method implemented in a communication system, such as, for example, the communication system of FIG. 7, in accordance with one embodiment. The communication system may include a host computer 24, a network node 16 and a WD 22, which may be those described with reference to FIGS. 7 and 8. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

FIG. 11 is a flowchart illustrating an exemplary method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

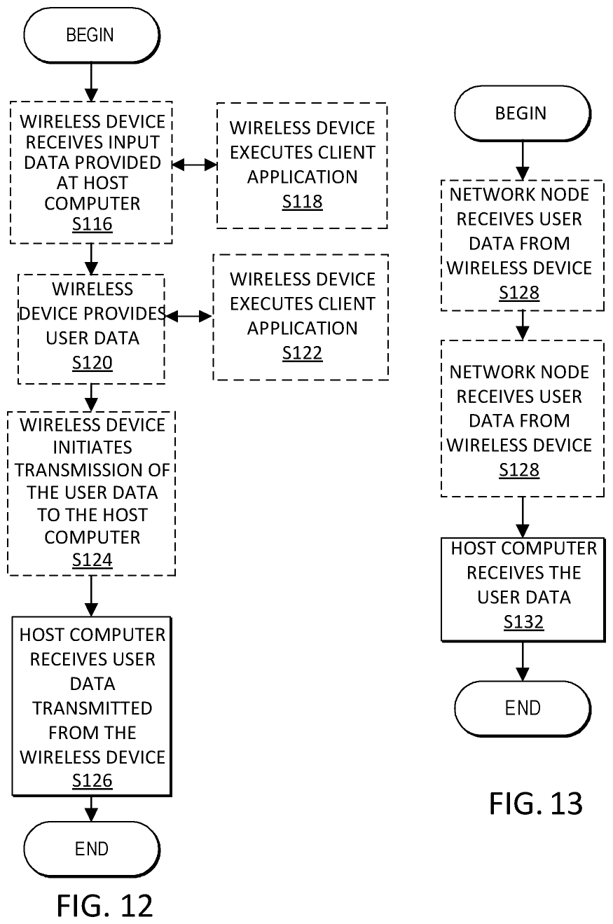

FIG. 12 is a flowchart illustrating an exemplary method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 13 is a flowchart of an exemplary process in a network node 16 for channel state information (CSI) omission for type II CSI. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to receive a channel state information, CSI, report from the WD (Block S134). The process also includes determining a priority of ports, layers and frequency domain, FD, bases based at least in part on a configuration of the CSI report (Block S136).

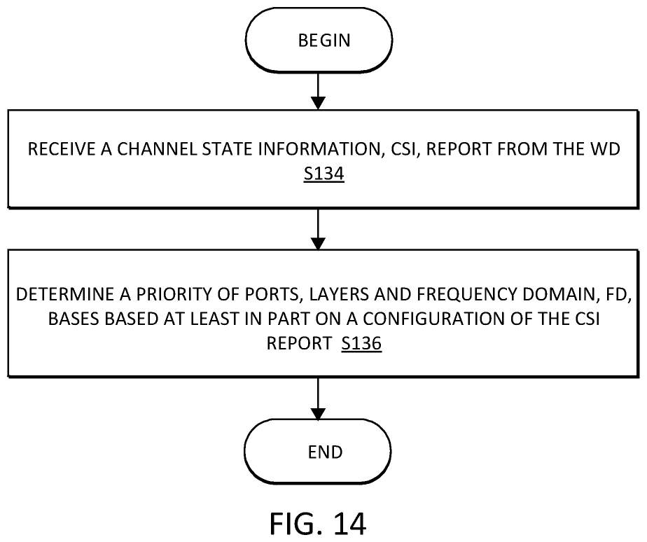

FIG. 14 is a flowchart of an exemplary process in a wireless device 22 according to some embodiments of the present disclosure. One or more blocks described herein may be performed by one or more elements of wireless device 22 such as by one or more of processing circuitry 84 (including the priority unit 34), processor 86, radio interface 82 and/or communication interface 60. Wireless device 22 is configured to receive a channel state information, CSI, configuration from the network node (Block S138). The process also includes reporting to the network node at least one of a: a group location for indicating a set of frequency domain, FD, basis vectors; a priority ordering for reporting elements of indices representing at least one of subband amplitude, a subband phase, and a bitmap for non-zero coefficients; and a group location for indicating at least one of the bitmap for non-zero coefficients, subband amplitude and phase coefficients (Block S140).

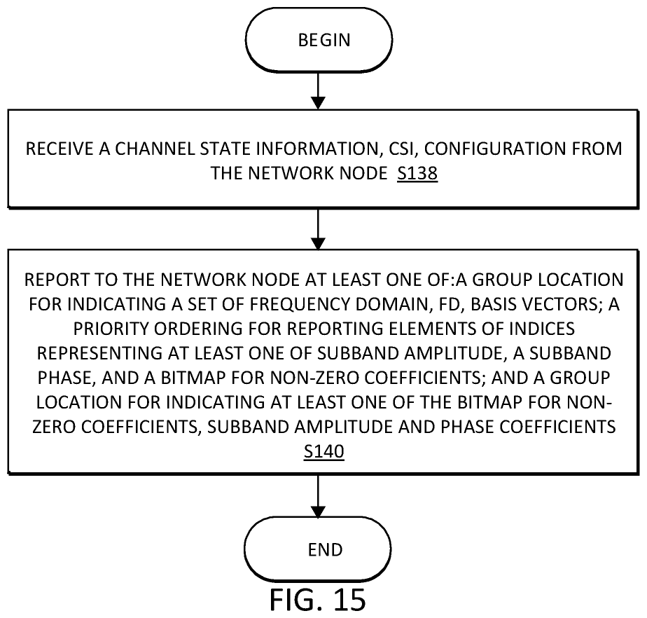

FIG. 15 is a flowchart of an exemplary process in a network node 16 for channel state information (CSI) omission for type II CSI. One or more blocks described herein may be performed by one or more elements of network node 16 such as by one or more of processing circuitry 68 (including the configuration unit 32), processor 70, radio interface 62 and/or communication interface 60. Network node 16 is configured to receive from the WD 22 an indication of a channel state information, CSI, reporting capability (Block S142). The process also includes configuring the WD 22 to report frequency domain, FD, basis vector information in one of a CSI reporting Group 1 and a CSI reporting Group 0, based at least in part on the indicated CSI reporting capability (Block S144).

In some embodiments, a codebook of the codebook based CSI is a port selection codebook and the CSI further comprises indices of multiple selected CSI reference signal, CSI-RS, ports. In some embodiments, the port selection codebook is an enhanced type II port selection codebook defined in 3GPP New Radio Technical Release 17 and the WD 22 is configured to report the FD basis vector information in CSI reporting Group 0. In some embodiments, the FD basis vector information includes an index indicating a set of selected FD basis vectors. In some embodiments, the CSI further includes information of a plurality of layers and the FD basis vector information includes FD basis vector information for each layer of the plurality of layers. In some embodiments, the plurality of layers, a plurality of ports and the FD basis vectors are prioritized from highest to lowest in an order of FD basis vectors, ports and then layers.

In some embodiments, the CSI further comprises a set of non-zero subband coefficients and an associated non-zero bitmap for each layer, at least one of the non-zero subband coefficients and bits of the bitmap associated with an FD basis vector having a smallest index being assigned a highest priority. In some embodiments, each of the non-zero subband coefficients comprises an amplitude and phase. In some embodiments, at least one of the non-zero bitmap and the non-zero subband coefficients for all layers are reported in a same CSI reporting group. In some embodiments, the non-zero bitmap and the set of non-zero subband coefficients for each of the plurality of layers are reported in a different CSI reporting group. In some embodiments, the non-zero bitmap for a set of non-zero subband coefficients and the set of non-zero subband coefficients are reported in one of CSI reporting Group 1 and 0 based at least in part on a priority.

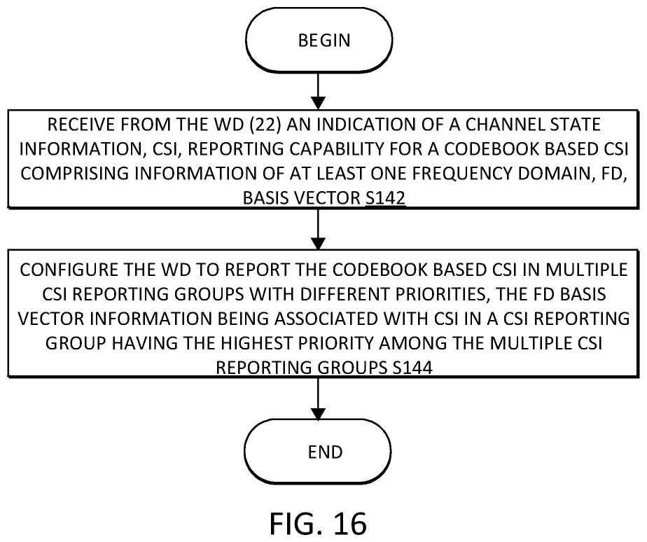

FIG. 16 is a flowchart of an exemplary process in a wireless device 22 according to some embodiments of the present disclosure. One or more blocks described herein may be performed by one or more elements of wireless device 22 such as by one or more of processing circuitry 84 (including the priority unit 34), processor 86, radio interface 82 and/or communication interface 60. Wireless device 22 is configured to receive from the WD 22 an indication of a channel state information, CSI, reporting capability for a codebook based CSI comprising information of at least one frequency domain, FD, basis vector (Block S146). The process also includes configuring the WD 22 to report the codebook based CSI in multiple CSI reporting groups with different priorities, the FD basis vector information being associated with CSI in a CSI reporting Group having the highest priority among the multiple CSI reporting groups (Block S148).

In some embodiments, the method includes reporting the FD basis vector information in CSI reporting Group 1 for a Type II port selection codebook defined in Third Generation Partnership Project Technical Release 16, 3GPP Rel-16, and reporting the FD basis vector information in CSI reporting Group 0 for a Type II port selection codebook defined in 3GPP Technical Release 17, 3GPP Rel-17. In some embodiments, the FD basis vector information includes an index indicating a set of selected FD basis vectors. In some embodiments, the codebook CSI further includes information of a plurality of layers and the FD basis vector information includes FD basis vector information for each layer of the plurality of layers. In some embodiments, the layers, a plurality of ports and the FD bases vectors are prioritized from highest to lowest in an order of FD basis, ports and then layers. In some embodiments, at least one of a non-zero bitmap and subband coefficients for all layers are reported in a same CSI reporting group. In some embodiments, at least one of a bitmap and a subband amplitude and phase for each of a plurality of subsets of layers are reported in a different CSI reporting group. In some embodiments, a non-zero bitmap for a set of non-zero subband coefficients and the set of non-zero subband coefficients are reported in one of CSI reporting Group 1 and 0 based at least in part on a priority.

Having described the general process flow of arrangements of the disclosure and having provided examples of hardware and software arrangements for implementing the processes and functions of the disclosure, the sections below provide details and examples of arrangements for channel state information (CSI) omission for type II CSI.

### Reporting Selected FD Basis Vectors in Group 0

A problem with the 3GPP Rel-16 CSI omission rules is that the network node 16 may not be able to reconstruct the channel based on incomplete PMI feedback in some cases. According to the 3GPP Rel-16 CSI report grouping and omission rules, the selected FD basis vectors by WD 22 are reported in Group 1. In some cases, if only Group 0, which has the highest priority, is reported (i.e., Group 1 and 2 are omitted), the network node 16 would have no information (or incomplete information) regarding which FD basis vectors are selected by WD 22, which may be essential information for the 3GPP Rel-17 Type II.

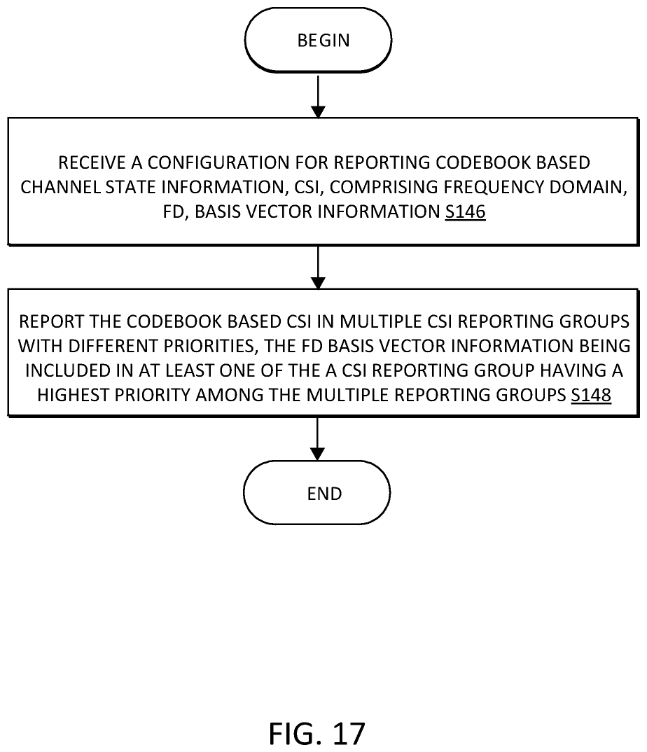

To further explain the above, consider the example shown in FIG. 17, where 4 CSI-RS ports are configured to the WD 22 which should all be selected. The 4 ports are used to cover 7 dominant clusters in the propagation channel, denoted as A-G. Furthermore, the WD 22 is configured to select M=2 FD basis vectors (i.e., delay taps) from an FD window of size N=4 (i.e., the 4 taps encircled by dashed lines).

The first 2 taps (i.e., FD basis vectors 0 and 1) are used by the WD 22 to calculate PMI. If the selected FD basis vectors are not known to the network node 16 due to Group 1 being omitted, network node 16 would not be able to calculate the correct the DL channel based only on the selected ports in Group 0. For example, if, in the worst case, the network node 16 assumes that FD basis vectors 2 and 3 are used, the DL precoder will totally mismatch the true DL channel, so that signals transmitted with this precoder may cancel out at the WD 22.

Note that even if the 3GPP considers a solution of rotating the selected FD basis vectors, such that FD basis vector 0, the DC FD component, is always selected, the network node 16 still cannot figure out the remaining taps if M>1.

In light of the above, knowledge of the selected FD basis vectors is used by the network node 16 to reconstruct the DL channel even when CSI omission happens.

Some embodiments determine the group location for indicating the selected FD basis vectors depending on the report configuration. When a 3GPP Rel-16 Type II or Type TT port selection reporting is configured, then FD basis vector information is carried on Group 1. When a 3GPP Rel-17 Type II reporting is configured, then FD basis information is carried in Group 0.

Hence, the WD 22 may report as a capability, support for 3GPP Rel-17 and/or 3GPP Rel-16 Type II reporting. The network configures the preferred Type II reporting mode/release and based on this information, the network and WD 22 have the same knowledge of whether FD bases are in group 1 or in group 0.

In one embodiment, the index for reporting the selected FD basis vectors for 3GPP Rel-17 Type II (e.g., i_1,6 if layer-common FD basis vectors are selected or i_(1,6,l) for layer 1 if layer-specific FD basis vectors are selected), is reported in CSI report Group 0.

In another variant of the above embodiment for 3GPP Rel-17 Type II reporting, the index for reporting the selected FD basis vectors (e.g., i_1,6 if layer-common FD basis vectors are selected, or i_(1,6,l) for layer 1 if layer-specific FD basis vectors are selected), are encoded in PMI field X_1, as defined in 3GPP TS 38.212 V 16.0.0, and reported in CSI report Group 0.

Note that reporting the selected FD basis vectors in Group 0 only imposes minor overhead increase for Group 0, since the selected FD basis vectors are layer-common, and the overhead may be at most “log” (┌(4|2)┐)=3 bits when N=4 and M=2.

### Reordering of Priority Function

The existing 3GPP Rel-16 Type II priority function for CSI omission does not have a proper ordering in terms of the priority of port, FD basis vector and layer, as further explained below.

For the 3GPP Rel-16 Type II reports, for a given CSI report, each reported element of indices i_{2,4,l} (subband amplitude), i_{2,5,l} (subband phase) and i_{1,7,l} (bitmap), indexed by l, i and f, is associated with a priority value given by the function Pri(l, i, f)=2·L·υ·π(f)+υ·i+l, with π(f)=min (2·n_{3,l}^{(f)}, 2·(N₃−n_{3,l}^{(f)})−1) with l=1,2, . . . , υ being the layer index and v being the RI, i=0,1, . . . ,2 L−1 being the index of selected ports, f=0,1, . . . , M_{υ}−1 being the index of selected FD basis vectors and M_{υ} being the number of selected FD basis vectors for each layer, and n_{3,l}^{(f)}∈{0, 1, . . . , N₃−1} being the index of FD basis vectors from which the WD 22 can select, and N₃ is the number of PMI subbands. The element with the highest priority has the lowest associated value Pri(l, i, f). Given the possible parameter configurations in Table 1 for 3GPP Rel-16 Type II, it may be observed that the priority order, from high to low, is given by layer to port to FD basis, which is not proper given the importance of the selected FD basis.

Based on the above argument, the index of the selected FD basis vector should be associated with the higher priority in the 3GPP Rel-17 Type II priority function.

Some embodiments provide arrangements for priority handling in the priority function if 3GPP Rel-17 Type II is configured.

In one embodiment, the priority ordering in the 3GPP Rel-17 Type II, from highest to lowest, may be FD basis to port to layer.

In another embodiment, the priority ordering in the 3GPP Rel-17 Type II, from highest to lowest, may be port to FD basis to layer.

Some embodiments determine priority ordering based on the report configuration. If a 3GPP Rel. 16 Type II or 3GPP Rel. 16 Type II port selection CSI reporting is configured, then the priority order from highest to lowest is determined in the order of layers, ports, and FD basis. If a 3GPP Rel-17 Type II reporting is configured, then the priority order from highest to lowest is determined according to one of the following:
priority order determined in the order of FD basis, ports and layers; or
priority order determined in the order of ports, FD basis and layers.

Hence, the WD 22 may report as a capability the support for 3GPP Rel-17 and/or 3GPP Rel-16 Type II reporting. The network configures the preferred Type II reporting mode/release and based on this information, the network and WD 22 have the same knowledge of priority order for CSI omission.

Another problem with the 3GPP Rel-16 Type II priority function is that an FD basis vector that is closer to the zero-th FD basis vector has higher priority in a circularly manner, which can be inferred from the value of π(f). This is also no longer true for the 3GPP Rel-17 Type II, because it would impose greater WD 22 implementation complexity.

Some embodiments provide solutions for handling the priority ordering for selected FD basis vectors.

In one embodiment, a subband coefficient or bitmap associated with an FD basis with smaller index has higher priority, e.g., bitmap or subband coefficients for FD basis vector 0 have higher priority than those for FD basis vector 1.

In a variant of the above embodiment, shifting of FD basis vectors is first applied so that the strongest coefficient indicator (SCI) is associated with the zero-th FD basis vector. Then a subband coefficient or bitmap associated with an FD basis with smaller index has higher priority, e.g., bitmap or subband coefficients for FD basis vector 0 have higher priority than those for FD basis vector 1.

### Grouping of Bitmap and Subband Amplitude and Phase

In 3GPP Rel-16 Type II, the subband PMI reporting can still be payload heavy even though FD compression has been adopted. One of the reasons is that the number of FD basis vectors for compressing the FD channel is proportional to the number of PMI subbands, which makes the total number of coefficients being reported potentially large for large bandwidth.

Therefore, in 3GPP Rel-16, the subband PMI, including bitmap for indicating non-zero coefficient (NZC) i_{1,7,l} and amplitude i_{2,4,l} and phase i_{2,5,l} of subband coefficients, which are encoded in information PMI field X₂, as defined in, for example, 3GPP TS 38.212 V16.0.0, are segmented into two groups: Group 1 and Group 2. The part of the bitmap and subband amplitude and phase that have a higher priority, which is calculated based on the 3GPP Rel-16 Type II priority function, is reported in Group 1, while the remaining part of bitmap and subband amplitude and phase are reported in Group 2.

The above grouping may not be necessary in 3GPP Rel-17 Type II, as the UCI payload can be greatly reduced comparing to that of 3GPP Rel-16 Type II. For example, the number of reported subband coefficients no longer scale with bandwidth. Thus, it is reasonable to have unified subband reporting to reduce complexity for encoding/decoding the CSI report. Some solutions are provided for grouping the bitmap and the amplitude and phase for subband amplitude if 3GPP Rel-17 Type II is configured. In one embodiment, the complete bitmap is reported in the same CSI group, for example, Group 1.

In another embodiment, both the complete bitmap and subband amplitude and phase are reported in the same CST group, for example, Group 1.

### Grouping by Layer Index

Since a layer may have the lowest priority in 3GPP Rel-17 Type II, grouping of CSI reports can also be reworked based on layer index. This makes sense since the network node 16 should still be able to recover part of the CSI based on PMI reporting for a subset of layers. Some embodiments provide solutions for grouping the NZC bitmap and subband amplitude and phase in Part 2 CSI if 3GPP Rel-17 Type II is configured.

In one embodiment, Part 2 of the CSI report is segmented into v groups, where v is the rank indicator (RI). The NZC bitmap and subband amplitude and phase for each layer is reported in a unique group (for example, those for layer v is reported in CSI Group v).

In another embodiment, Part 2 of the CSI report is segmented in to 2 groups, where each group contains the NZC bitmap and subband amplitude and phase for a pre-defined (e.g., specified in 3GPP) subset of layers. For example, Group 1 contains those for layer 1 and 2, Group 2 contains those for layer 3.

Some embodiments determine the group location for indicating the bitmap for non-zero coefficients, subband amplitude and phase coefficients depending on the report configuration. If a 3GPP Rel.16 Type II or Type II port selection reporting is configured, then the bitmap for non-zero coefficients, subband amplitude and phase coefficients are segmented into two groups wherein part of the bitmap for non-zero coefficients, subband amplitude and phase that have higher priority, which is calculated based on the 3GPP Rel-16 Type II priority function, is reported in Group 1, while the remaining part of bitmap and subband amplitude and phase are reported in Group 2.

If a 3GPP Rel-17 Type II reporting is configured, then the group location for indicating the bitmap for non-zero coefficients, subband amplitude and/or phase coefficients may be determined according to one of the following non-limiting examples:
the bitmap for non-zero coefficients are reported in a single group;
the bitmap for non-zero coefficients, subband amplitude and phase coefficients are reported in the same CSI group; and/or
the bitmap for non-zero coefficients, subband amplitude and phase coefficients for a given layer is reported in the same CSI group, wherein each CSI group contains the bitmap for non-zero coefficients, subband amplitude and phase coefficients for one or multiple layers.

Hence, the WD may report as a capability the support for 3GPP Rel-17 and/or 3GPP Rel.16 Type II reporting. The network configures the preferred Type II reporting mode/release and based on this information, the network and WD 22 has the same knowledge of the grouping information of bitmap for non-zero coefficients, subband amplitude and phase coefficients.

Some embodiments may include some or all of the following:

Embodiment 1. A method of CSI reporting where:
Step 1: the WD 22 receives a configuration of a type of Type II CSI reporting in CSI reporting configuration;
Step 2: the WD 22 computes CSI based on the received configuration of the type of Type II CSI reporting;
Step 3: the WD 22 determines based on the configuration of the type of Type II CSI reporting at least one of the following:
   group location in part 2 of the CSI for indicating the selected FD basis vectors;
   priority ordering for reporting for reporting elements of indices representing subband amplitude, subband phase, and bitmap for non-zero coefficients;
   the group location for indicating the bitmap for non-zero coefficients, subband amplitude and/or phase coefficients; and/or
Step 4: the WD 22 reports CSI based on the determination in Step 3.

Embodiment 2. The method of Embodiment 1, wherein when the type of Type II CSI reporting is configured to 3GPP Rel-16 Type II (i.e., enhanced Type II codebook) or 3GPP Rel-16 Type II port selection (i.e., Enhanced Type II port selection codebook), the FD basis vector information is carried in the second group (i.e., Group 1) in part 2 of the CST; and wherein when the type of Type II CSI reporting is configured to 3GPP Rel-17 Type II, the FD basis vector information is carried in the first group (i.e., Group 0) in part 2 of the CSI.

Embodiment 3. The method of Embodiment 1, wherein when the type of Type II CSI reporting is configured 3GPP Rel-16 Type II (i.e., enhanced Type II codebook) or 3GPP Rel-16 Type II port selection (i.e., Enhanced Type II port selection codebook), the priority order from highest to lowest is determined in the order of layers, ports, and FD basis; and wherein when the type of Type II CSI reporting is configured to 3GPP Rel-17 Type II, the priority order from highest to lowest is determined according to one of the following: priority order determined in the order of FD basis, ports and layers; or priority order determined in the order of ports, FD basis and layers.

Embodiment 4. The method of Embodiment 1, wherein when the type of Type II CSI reporting is configured to 3GPP Rel-16 Type II (i.e., enhanced Type II codebook) or 3GPP Rel-16 Type II port selection (i.e., Enhanced Type II port selection codebook), the bitmap for non-zero coefficients, subband amplitude and phase coefficients are segmented into two groups where part of the bitmap for non-zero coefficients, subband amplitude and phase is reported in second group (i.e., Group 1) in part 2 of the CSI, while the remaining part of bitmap and subband amplitude and phase are reported in the third group (i.e., Group 2) in part 2 of the CSI; and wherein when the type of Type II CSI reporting is configured to 3GPP Rel-17 Type II, the group location for indicating the bitmap for non-zero coefficients, subband amplitude and/or phase coefficients is determined according to one of the following:
the bitmap for non-zero coefficients are reported in a single group in part 2 of the CSI;
the bitmap for non-zero coefficients, subband amplitude and phase coefficients are reported in the same group in part 2 of the CST; and/or
the bitmap for non-zero coefficients, subband amplitude and phase coefficients for a given layer is reported in the same CSI group, wherein each CSI group contains the bitmap for non-zero coefficients, subband amplitude and phase coefficients for one or multiple layers.

According to one aspect, a network node 16 is configured to communicate with a wireless device 22 (WD 22). The network node 16 includes a radio interface 62 and/or processing circuitry 68 configured to: receive a channel state information, CSI, report from the WD 22; and determine a priority of ports, layers and frequency domain, FD, bases based at least in part on a configuration of the CSI report.

According to this aspect, in some embodiments, the priority is in an order of FD bases, port, and then layer. In some embodiments, the priority is in an order of port, FD bases, and then layer. In some embodiments, the priority is in an order of layers, ports, and then FD bases. In some embodiments,

According to another aspect, a method implemented in a network node 16 includes receiving a channel state information, CSI, report from the WD 22 and determining a priority of ports, layers and frequency domain, FD, bases based at least in part on a configuration of the CSI report.

According to this aspect, in some embodiments, the priority is in an order of FD bases, port, and then layer. In some embodiments, the priority is in an order of port, FD bases, and then layer. In some embodiments, the priority is in an order of layers, ports, and then FD bases.

According to yet another aspect, a wireless device (WD) 22 is configured to communicate with a network node 16. The WD 22 includes a radio interface 82 and/or processing circuitry 84 configured to: receive a channel state information, CSI, configuration from the network node 16; and report to the network node 16 at least one of: a group location for indicating a set of frequency domain, FD, basis vectors; a priority ordering for reporting elements of indices representing at least one of subband amplitude, a subband phase, and a bitmap for non-zero coefficients; and a group location for indicating at least one of the bitmap for non-zero coefficients, subband amplitude and phase coefficients.

According to this aspect, in some embodiments, when a type of Type II CSI reporting is configured to one of an enhanced Type TT codebook and an enhanced Type II port selection codebook, FD basis vector information is carried in a second group in part 2 of the CSI. In some embodiments, the FD basis vector information is carried in a first group in part 2 of the CSI. In some embodiments, a type of Type II CSI reporting includes at least one of a priority in an order of FD basis vectors, ports and then layers, and in an order of ports, FD basis vectors and then layers.

According to another aspect, a method implemented in a wireless device (WD 22), includes: receiving a channel state information, CSI, configuration from the network node 16; and reporting to the network node 16 at least one of a: a group location for indicating a set of frequency domain, FD, basis vectors; a priority ordering for reporting elements of indices representing at least one of subband amplitude, a subband phase, and a bitmap for non-zero coefficients; and a group location for indicating at least one of the bitmap for non-zero coefficients, subband amplitude and phase coefficients.

According to this aspect, in some embodiments, when a type of Type II CSI reporting is configured to one of an enhanced Type II codebook and an enhanced Type II port selection codebook, FD basis vector information is carried in a second group in part 2 of the CSI. In some embodiments, the FD basis vector information is carried in a first group in part 2 of the CSI. In some embodiments, a type of Type II CSI reporting includes at least one of a priority in an order of FD basis vectors, ports and then layers, and in an order of ports, FD basis vectors and then layers.

### Some Example

Example A1. A network node 16 configured to communicate with a wireless device 22 (WD 22), the network node 16 configured to, and/or comprising a radio interface 62 and/or comprising processing circuitry 68 configured to:
receive a channel state information, CSI, report from the WD 22; and
determine a priority of ports, layers and frequency domain, FD, bases based at least in part on a configuration of the CSI report.

Example A2. The network node 16 of Example A1, wherein the priority is in an order of FD bases, port, and then layer.

Example A3. The network node 16 of Example A1, wherein the priority is in an order of port, FD bases, and then layer.

Example A4. The network node 16 of Example A1, wherein the priority is in an order of layers, ports, and then FD bases.

Example B1. A method implemented in a network node 16, the method comprising:
receiving a channel state information, CSI, report from the WD 22; and
determining a priority of ports, layers and frequency domain, FD, bases based at least in part on a configuration of the CSI report.

Example B2. The method of Example B1, wherein the priority is in an order of FD bases, port, and then layer.

Example B3. The method of Example B1, wherein the priority is in an order of port, FD bases, and then layer.

Example B4. The method of Example B1, wherein the priority is in an order of layers, ports, and then FD bases.

Example C1. A wireless device 22 (WD 22) configured to communicate with a network node 16, the WD 22 configured to, and/or comprising a radio interface 82 and/or processing circuitry 84 configured to:
receive a channel state information, CSI, configuration from the network node 16; and
report to the network node 16 at least one of:
   a group location for indicating a set of frequency domain, FD, basis vectors;
   a priority ordering for reporting elements of indices representing at least one of subband amplitude, a subband phase, and a bitmap for non-zero coefficients; and
   a group location for indicating at least one of the bitmap for non-zero coefficients, subband amplitude and phase coefficients.

Example C2. The WD 22 of Example C1, wherein when a type of Type II CSI reporting is configured to one of an enhanced Type II codebook and an enhanced Type II port selection codebook, FD basis vector information is carried in a second group in part 2 of the CSI.

Example C3. The WD 22 of Example C2, wherein the FD basis vector information is carried in a first group in part 2 of the CSI

Example C4. The WD 22 of Examples C1-C3, wherein a type of Type II CSI reporting includes at least one of a priority in an order of FD basis vectors, ports and then layers, and in an order of ports, FD basis vectors and then layers.

Example D1. A method implemented in a wireless device 22 (WD 22), the method comprising:
receiving a channel state information, CSI, configuration from the network node 16; and
reporting to the network node 16 at least one of a:
   a group location for indicating a set of frequency domain, FD, basis vectors;
   a priority ordering for reporting elements of indices representing at least one of subband amplitude, a subband phase, and a bitmap for non-zero coefficients; and
   a group location for indicating at least one of the bitmap for non-zero coefficients, subband amplitude and phase coefficients.

Example D2. The method of Example D1, wherein when a type of Type II CSI reporting is configured to one of an enhanced Type II codebook and an enhanced Type II port selection codebook, FD basis vector information is carried in a second group in part 2 of the CSI.

Example D3. The method of Example D2, wherein the FD basis vector information is carried in a first group in part 2 of the CSI

Example D4. The method of Examples D1-D3, wherein a type of Type II CSI reporting includes at least one of a priority in an order of FD basis vectors, ports and then layers, and in an order of ports, FD basis vectors and then layers.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a wireless device, WD, the method comprising:
receiving from the WD an indication of a channel state information, CSI, reporting capability for a codebook based CSI comprising information of at least one frequency domain, FD, basis vector; and
configuring the WD to report the codebook based CSI in multiple CSI reporting groups with different priorities, the FD basis vector information being associated with CSI in a CSI reporting group of the multiple CSI reporting groups, a first CSI reporting group including first CSI grouped according to a priority criterion when a number of reported sub-band coefficients scales with bandwidth or according to a sub-band criterion when the number of reported sub-band coefficients does not scale with bandwidth.

2. The method of claim 1, wherein a codebook of the codebook based CSI is a port selection codebook and the CSI further comprises indices of multiple selected CSI reference signal, CSI-RS, ports.

3. The method of claim 2, wherein the port selection codebook is an enhanced type II port selection codebook defined in 3GPP New Radio Technical Release 17 and the WD is configured to report the FD basis vector information in CSI reporting Group 0.

4. The method of claim 1, wherein the FD basis vector information includes an index indicating a set of selected FD basis vectors.

5. The method claim 1, wherein the CSI further includes information of a plurality of layers and the FD basis vector information includes FD basis vector information for each layer of the plurality of layers.

6. The method of claim 5, wherein the plurality of layers, a plurality of ports and the FD basis vectors are prioritized from highest to lowest in an order of FD basis vectors, ports and then layers.

7. The method of claim 5, wherein the CSI further comprises a set of non-zero subband coefficients and an associated non-zero bitmap for each layer, at least one of the non-zero subband coefficients and bits of the bitmap associated with an FD basis vector having a smallest index being assigned a highest priority.

8. The method of claim 7, wherein each of the non-zero subband coefficients comprises an amplitude and phase.

9. The method of claim 7, wherein at least one of the non-zero bitmap and the non-zero subband coefficients for all layers are reported in a same CSI reporting group.

10. The method of claim 7, wherein the non-zero bitmap and the set of non-zero subband coefficients for each of the plurality of layers are reported in a different CSI reporting group.

11. The method of claim 7, wherein the non-zero bitmap for a set of non-zero subband coefficients and the set of non-zero subband coefficients are reported in one of CSI reporting Group 1 and 0 based at least in part on a priority.

12. A network node configured to communicate with a wireless device, WD, the network node comprising:
a radio interface configured to receive from the WD an indication of a channel state information, CSI, reporting capability for a codebook based CSI comprising information of at least one frequency domain, FD, basis vector; and
configure the WD to report the codebook based CSI in multiple CSI reporting groups with different priorities, the FD basis vector information being associated with CSI in a CSI reporting group of the multiple CSI reporting groups, a first CSI reporting group including first CSI grouped according to a priority criterion when a number of reported sub-band coefficients scales with bandwidth or according to a sub-band criterion when the number of reported sub-band coefficients does not scale with bandwidth.

13. The network node of claim 12, wherein a codebook of the codebook based CSI is a port selection codebook and the CSI further comprises indices of multiple selected CSI reference signal, CSI-RS, ports.

14. The network node of claim 13, wherein the port selection codebook is an enhanced type II port selection codebook defined in 3GPP New Radio Technical Release 17 and the WD is configured to report the FD basis vector information in CSI reporting Group 0.

15. The network node of claim 12, wherein the FD basis vector information includes an index indicating a set of selected FD basis vectors.

16. The network node of claim 12, wherein the CSI further includes information of a plurality of layers and the FD basis vector information includes FD basis vector information for each layer of the plurality of layers.

17. The network node of claim 16, wherein the layers, a plurality of ports and the FD basis vectors are prioritized from highest to lowest in an order of FD basis vectors, ports and then layers.

18. The network node of claim 16, wherein the CSI further comprises a set of non-zero subband coefficients and an associated non-zero bitmap for each layer, at least one of the non-zero subband coefficients and bits of the bitmap associated with an FD basis vector having a smallest index being assigned a highest priority.

19. The network node of claim 18, wherein each of the non-zero subband coefficients comprises an amplitude and phase.

20. The network node of claim 18, wherein at least one of the non-zero bitmap and the set of non-zero subband coefficients for all layers are reported in a same CSI reporting group.

21. The network node of claim 18, wherein the non-zero bitmap and the non-zero subband coefficients for each of the plurality of layers are reported in a different CSI reporting group.

22. The network node of claim 18, wherein the non-zero bitmap for a set of non-zero subband coefficients and the set of non-zero subband coefficients are reported in one of CSI reporting Group 1 and 0 based at least in part on a priority.

23. A method in a wireless device, WD, configured to communicate with a network node, the method comprising:
receiving a configuration for reporting codebook based channel state information, CSI, comprising frequency domain, FD, basis vector information; and
reporting the codebook based CSI in multiple CSI reporting groups with different priorities, the FD basis vector information being included in a CSI reporting group of the multiple CSI reporting groups,
a first CSI reporting group including first CSI grouped according to a priority criterion when a number of reported sub-band coefficients scales with bandwidth or according to a sub-band criterion when the number of reported sub-band coefficients does not scale with bandwidth.

24. The method of claim 23, further comprising reporting the FD basis vector information in CSI reporting Group 1 for a Type II port selection codebook defined in Third Generation Partnership Project Technical Release 16, 3GPP Rel-16, and reporting the FD basis vector information in CSI reporting Group 0 for a Type II port selection codebook defined in 3GPP Technical Release 17, 3GPP Rel-17.

25. The method of claim 23, wherein the FD basis vector information includes an index indicating a set of selected FD basis vectors.

26. The method claim 23, wherein the codebook CSI further includes information of a plurality of layers and the FD basis vector information includes FD basis vector information for each layer of the plurality of layers.

27. The method of claim 26, wherein the layers, a plurality of ports and the FD bases vectors are prioritized from highest to lowest in an order of FD basis, ports and then layers.

28. The method of claim 26, wherein at least one of a non-zero bitmap and subband coefficients for all layers are reported in a same CSI reporting group.

29. The method of claim 23, wherein at least one of a bitmap and a subband amplitude and phase for each of a plurality of subsets of layers are reported in a different CSI reporting group.

30. The method of claim 23, wherein a non-zero bitmap for a set of non-zero subband coefficients and the set of non-zero subband coefficients are reported in one of CSI reporting Group 1 and 0 based at least in part on a priority.

31. A wireless device, WD, configured to communicate with a network node, the WD comprising:
a radio interface configured to:
receive a configuration for reporting codebook based channel state information, CSI, comprising frequency domain, FD, basis vector information; and
report the codebook based CSI in multiple CSI reporting groups with different priorities, the FD basis vector information being included in a CSI reporting group of the multiple CSI reporting groups, a first CSI reporting group including first CSI grouped according to a priority criterion when a number of reported sub-band coefficients scales with bandwidth or according to a sub-band criterion when the number of reported sub-band coefficients does not scale with bandwidth.

32. The WD of claim 31, wherein the reporting includes reporting the FD basis vector information in CSI reporting Group 1 for a Type II port selection codebook defined in Third Generation Partnership Project Technical Release 16, 3GPP Rel-16, and reporting the FD basis vector information in CSI reporting Group 0 for a Type II port selection codebook defined in 3GPP Technical Release 17, 3GPP Rel-17.

33. The WD of claim 31, wherein the FD basis vector information includes an index indicating a set of selected FD basis vectors.

34. The WD of claim 31, wherein the codebook CSI further includes information of a plurality of layers and the FD basis vector information includes FD basis vector information for each layer of the plurality of layers.

35. The WD of claim 34, wherein the layers, a plurality of ports and the FD bases vectors are prioritized from highest to lowest in an order of FD basis, ports and then layers.

36. The WD of claim 34, wherein at least one of a non-zero bitmap and subband coefficients for all layers are reported in a same CSI reporting group.

37. The WD of claim 31, wherein at least one of a bitmap and a subband amplitude and phase for each of a plurality of subsets of layers are reported in a different CSI reporting group.

38. The WD of claim 31, wherein a non-zero bitmap for a set of non-zero subband coefficients and the set of non-zero subband coefficients are reported in one of CSI reporting Group 1 and 0 based at least in part on a priority.
